(19) United States
(12) Patent Application Publication
(10) Pub. No.: US 2003/0086814 A1
(43) Pub. Date: May 8, 2003

(54) Odor control method

(76) Inventor: Ellen M. Meyer, Cleveland, TN (US)

Correspondence Address: Steven D. Boyd, BetzDearborn Inc., 4636 Somerton Road, Trevose, PA, 19053-6783, US

(21) Appl. No.: 10/022,472

(22) Filed: Oct. 30, 2001

(51) Int. Cl. C02F 1/76

(52) U.S. Cl. 422/5; 422/1; 210/753

(57) ABSTRACT

A method of controlling objectionable odors in and around aqueous systems is disclosed. The method comprises adding to the aqueous system or spraying into the atmosphere adjacent to the aqueous system an odor control treatment comprising an organic halogen donor species. Typical organic halogen donor species include halogenated succinimides, halogenated hydantoins, halogenated isothiazolines and mixtures thereof.

### FIELD OF THE INVENTION

The present invention relates to a method for controlling objectionable odors in aqueous systems. More particularly, the present invention relates to the use of organic halogen donating species to control objectionable sulfur, nitrogen and/or fatty acid based odors in aqueous systems.

### BACKGROUND OF THE INVENTION

Objectionable odors in an aqueous system such as an industrial aqueous system can present both aesthetic and health concerns. For example, the presence of sulfur species such as hydrogen sulfide, mercaptans and sulfides; nitrogen species such as amines and indoles; and fatty acids species can give rise to objectionable odors. The existence of such objectionable odors can be a problem aesthetically. For example, homes, schools, parks or businesses located near an industrial facility that emits hydrogen sulfide odors will find such odors objectionable. In addition, health issues may arise. For example, the maximum permissible 8-hour concentration for hydrogen sulfide is about 20 ppm (Occupational Safety and Health Standards, Department of Labor, OSHA, Federal Register, 37,22142 (Oct. 18, 1972)). Nitrogen species such as amines and indoles result in similar issues arising when present in an aqueous system. Hydrogen sulfide is particularly problematic due to its very low odor threshold, toxicity and because of its corrosion capability.

Odor control methods can be chemical or mechanical. Ventilation of indoor air is often employed. If the air is vented without treatment, the odoriferous air is simply diluted by the outside air so that the concentrations of odor causing chemicals are below the detection threshold. Alternatively, exhaust air may be treated in scrubbers, biofilters or absorption units. In scrubbers, the water may contain chemicals which increase the efficiency and/or react with the odor causing chemicals. For example, acid gases are often scrubbed with a caustic solution or a combination of caustic and sodium hypochlorite. In biofilters, a solid support is seeded with microbial cultures which degrade the odor causing chemicals. A variety of supports and microbes are available for both liquid and gaseous streams. Adsorption units typically contain some sort of solid sorbent such as activated carbon or other high surface area material. Other mechanical solutions to odor include electrostatic precipitation and combustion.

Many chemical treatments for odor control are masking agents. Masking agents can be applied as solids, liquids or gases. Most of the essential oils (limonene, pinene, etc.) and esters used for odor control may be considered masking agents. Masking agents do not actually react with the odor-causing chemical but decrease the perception of the odor by overpowering it. Masking agents replace the objectionable odor with a more pleasing odor. Masking agents may exacerbate problems with odors such as hydrogen sulfide by decreasing the perception of the gas without decreasing its toxicity or corrosiveness. Often, the smell of the masking agent itself can become objectionable.

Odor neutralization is a phenomenon in which odors can seem to cancel each other. Rather than overpowering an offensive odor with a more pleasing one of a masking agent, the aim of neutralization is to produce a net zero odor. In the process of neutralization, there is no chemical interaction between the odor causing chemical and the neutralizing agent. Like masking agents, they can exacerbate a problem if the odor that is neutralized is also toxic. Another disadvantage of neutralizing agents is that a multi-component odor will typically require a multi-component blend of neutralizing chemicals. To completely neutralize complex odors, individual blends of neutralizing chemicals would need to be developed for each individual application.

Many chemicals can be used to react with offensive odor. Deodorization of hydrogen sulfide can be accomplished with a pH adjustment. At high pH, the equilibrium of the equation H₂S [symbol] H⁺+HS⁻ can be driven to form HS⁻. Since HS⁻ is water soluble and non-volatile it does not present the same odor, toxicity and corrosive properties as H₂S. However, if pH is allowed to drop, H₂S is easily reformed. Many odors, including hydrogen sulfide can be oxidized by air or chemical oxidizing agents such as sodium hypochlorite or ozone. Oxidation by air is usually too slow and inefficient for most commerical applications. Care must be taken in handling, formulating and using oxidants such as sodium hypochlorite and ozone. Sulfide may also be precipitated with metal ions such as iron and zinc. The use of amines and aldehydes for scavenging H₂S from natural gas and crude oil is well documented, however many of the chemicals are of limited use in aqueous systems that contain a variety of odor causing chemicals.

### SUMMARY OF THE INVENTION

In general, the present invention relates to removing odors from an aqueous system by adding an effective dosage of a treatment agent to the aqueous system or spraying it into to the atmosphere near the aqueous system. The problematic odors controlled by the present invention can be a result of odoriferous sulfur compounds, nitrogen compounds or fatty acid compounds present in the aqueous system. The odor control treatment of the present invention comprises a halogen donor organic molecule such as halogenated succinimides, halogenated hydantoins, halogenated isothiazolines, other halogenated organic compounds containing electron donating groups and mixtures thereof.

In accordance with the present invention, it has been found that halogen donor organic materials are effective at controlling undesirable odor of aqueous systems which results from the presence of odoriferous sulfur compounds, odoriferous nitrogen compounds and odoriferous fatty acid compounds. The halogen donor organic materials can be added directly to the aqueous stream, added to components such as scrubbers that contact the aqueous stream or sprayed into the atmosphere near the aqueous system. The odor control of the present invention is achieved by any means of bringing the halogen donor materials into contact with the odoriferous component of the aqueous system.

In one aspect of the present invention, it has been found that halogenated succinimide materials are effective at reducing odors of aqueous systems which result from the presence of odoriferous sulfur compounds, odoriferous nitrogen compounds and odoriferous fatty acid compounds.

In a further aspect of the present invention, it has been found that objectionable hydrogen sulfide odors from an aqueous system can be controlled by the addition of at least one organic halogen donor molecule of halogenated succinimides, halogenated hydantoins, halogenated isothiazolines, other halogenated organic compounds containing electron donating groups and mixtures thereof to the aqueous system.

### DETAILED DESCRIPTION OF THE INVENTION

The present invention involves controlling offensive odors from aqueous systems through the addition of organic halogen donor treatment agents to the aqueous system or the atmosphere near the aqueous system. Offensive odors such as odors caused by sulfur compounds, nitrogen compounds and fatty acid materials can be controlled by the method of the present invention.

Typical sulfur compounds which can cause objectionable odors when present in an aqueous system include hydrogen sulfide, mercaptans and sulfides. Typical nitrogen compounds which cause objectionable odors when present in an aqueous system include amines and indoles. Typical oxygen moieties which can cause objectionable odors when present in an aqueous system include fatty acids.

Organic halogen donor treatment agents of the present invention can include halogenated succinimides, halogenated hydantoins, halogenated isothiazolines and other halogenated organic compounds containing electron donating groups. Typical halogenated succinimides effective in the method of the present invention include N-chlorosuccinimide and N-bromosuccinimide. Typical halogenated hydantoins effective in the method of the present invention include 1-bromo-3-chloro-5,5-dimethylhydantion and 1,3-dichloro-5,5-dimethyl-hydantions 1,3-dibromo-5,5-dimethylhydantion and mixtures thereof. Typical halogenated isothiazolines include 5-chloro-2-methyl-4-isothiazolin-3-one and 5-bromo-2-methyl-4-isothiazolin-3-one and mixtures thereof. Typical halogenated organic compounds containing electron donating groups effective in the method of the present invention include 2,2-dibromo-3-nitrilopropionamide and 2-bromo-2-nitropropane-1,3-diol.

The organic halogen donating treatment agent of the present invention can be added directly to the aqueous system where odor control is desired. Addition to the aqueous system may be by direct addition or by addition to components that the aqueous stream contacts. Alternatively, the treatment may be sprayed into the atmosphere near the aqueous system. The actual amount of odor control treatment necessary to achieve the desired level of odor control will vary based upon the concentration and type of odor causing species in the aqueous system. Typical dosages of organic halogen donating materials to an aqueous stream for odor control within the scope of the present invention will range from about 1 to 1000 parts per million, preferably from about 1 to 500 parts per million and most preferably ranging from about 1 to 100 parts per million.

The present invention will now be further described with reference to a number of specific examples which are to be regarded as illustrative and not as restricting the scope of the present invention. In the examples, hydrogen sulfide was used as the odor causing material due to its prevalence in many industrial odor situations, its low odor threshold and its obnoxious odor. In addition, hydrogen sulfide is a toxic as well as corrosive material whose control in the industrial aqueous system is desirable.

### EXAMPLES

### Example 1

Testing was undertaken by adding sodium sulfide to a pH7 buffer solution in a closed chamber. The hydrogen sulfide concentration in the headspace was measured using an electrochemical hydrogen sulfide sensor.

A number of halogen donor materials were tested by adding varying dosages of treatment to the solution. Table 1 summarizes the results of the testing.

TABLE 1

| Treatment | Dosage (ppm) | H₂S Reading (ppm) |
|---|---|---|
| N-chlorosuccinimide | 0 | 143 |
| | 2 | 120 |
| | 4 | 90 |
| | 6 | 70 |
| | 8 | 46 |
| | 10 | 23 |
| | 12 | 5 |
| N-bromosuccinimide | 0 | 143 |
| | 4 | 113 |
| | 8 | 87 |
| | 12 | 59 |
| | 16 | 35 |
| | 20 | 16 |
| | 24 | 8 |
| 2-bromo-2-nitropropane- | 0 | 163 |
| 1,3-diol | 5 | 104 |
| | 10 | 83 |
| | 20 | 38 |
| | 30 | 21 |
| | 40 | 6 |
| 2,2-dibromo-3-nitrilo- | 0 | 143 |
| propionamide | 1.6 | 132 |
| | 3.2 | 112 |
| | 4.8 | 102 |
| | 6.4 | 81 |
| | 8 | 63 |
| | 9.6 | 49 |
| | 11.2 | 35 |
| | 12.8 | 23 |
| | 14.4 | 16 |
| | 16 | 6 |
| 5-chloro-2-methyl-4- | 0 | 158 |
| isothiazolin-3-one | 20 | 147 |
| | 40 | 104 |
| | 60 | 86 |
| | 80 | 61 |
| | 100 | 31 |
| | 120 | 21 |

### Example 2

Testing was undertaken using wastewater from a commercial meat processing facility. Organic halogen donor treatments were added to the wastewater in a closed chamber and hydrogen sulfide headspace concentration measurements were taken using an electrochemical hydrogen sulfide sensor. Table 2 summarizes the results.

TABLE 2

| Treatment | Dosage (ppm) | H₂S Reading (ppm) |
|---|---|---|
| N-chlorosuccinimide | 0 | 348 |
| | 4 | 155 |
| | 6 | 39 |
| | 8 | 28 |
| | 10 | 18 |
| | 12 | 5 |
| | 20 | 4 |
| 2-bromo-2-nitropropane-1,3-diol | 0 | 469 |
| | 10 | 216 |
| | 12 | 195 |
| | 14 | 78 |
| | 16 | 62 |
| | 18 | 37 |
| | 20 | 27 |

### Example 3

Testing was undertaken using sludge from a papermill. Organic halogen donor treatment was added to the sludge in a closed chamber and hydrogen sulfide headspace concentration readings were taken using an electrochemical hydrogen sulfide sensor. Table 3 summarizes the results.

TABLE 3

| Treatment | Dosage (ppm) | H2S Reading (ppm) |
|---|---|---|
| 2-bromo-2-nitropropane-1,3-diol | 0 | 158 |
| | 2.5 | 143 |
| | 5 | 97 |
| | 10 | 50 |
| | 15 | 28 |
| | 20 | 13 |
| | 21 | |

### Example 4

Testing was undertaken using sludge from a municipal waste treatment facility. Organic halogen donor treatment materials were added to the sludge in a closed chamber and hydrogen sulfide headspace concentration readings were taken using an electrochemical hydrogen sulfide sensor. Table 4 summarizes the results.

TABLE 4

| Treatment | Dosage (ppm) | H2S Reading (ppm) |
|---|---|---|
| N-chlorosuccinimide | 0 | 455 |
| | 20 | 453 |
| | 40 | 311 |
| | 50 | 205 |
| | 60 | 169 |
| | 70 | 165 |
| | 100 | 85 |
| | 200 | 34 |
| | 300 | 12 |
| | 400 | 0 |
| N-bromosuccinimide | 0 | 455 |
| | 40 | 435 |
| | 60 | 415 |
| | 70 | 335 |
| | 80 | 289 |
| | 100 | 218 |
| | 150 | 112 |
| | 200 | 85 |
| | 400 | 44 |
| | 600 | 25 |
| | 800 | 17 |
| | 1000 | 12 |

### Example 5

Testing was undertaken using wastewater from a food processing plant. Organic halogen donor treatment agents were added to the wastewater in a closed chamber and hydrogen sulfide headspace concentration readings were taken using an electrochemical hydrogen sulfide sensor. Table 5 summarizes the results.

TABLE 5

| Treatment | Dosage (ppm) | H2S Reading (ppm) |
|---|---|---|
| N-chlorosuccinimide | 0 | 189 |
| | 12 | 184 |
| | 20 | 97 |
| | 28 | 46 |
| | 40 | 6 |
| | 90 | 0 |
| N-bromosuccinimide | 0 | 189 |
| | 16 | 113 |
| | 20 | 109 |
| | 28 | 31 |
| | 40 | 35 |
| | 100 | 2 |

### Example 6

Testing was undertaken using leachate from a landfill. Organic halogen donor treatments were added to the leachate in a closed chamber and hydrogen sulfide headspace concentration readings were taken using an electrochemical hydrogen sulfide sensor. Table 6 summarizes the results.

TABLE 6

| Treatment | Dosage (ppm) | H2S Reading (ppm) |
|---|---|---|
| N-chlorosuccinimide | 0 | 181 |
| | 10 | 112 |
| | 50 | 109 |
| | 75 | 102 |
| | 90 | 21 |
| | 100 | 13 |
| | 120 | 2 |
| | 250 | 0 |
| N-bromosuccinimide | 0 | 171 |
| | 20 | 91 |
| | 50 | 86 |
| | 100 | 50 |
| | 160 | 12 |
| | 200 | 2 |
| | 400 | 0 |

The data in tables 1-6 show the efficiency of organic halogen donors tested in preventing airborne hydrogen sulfide and thereby inhibiting the accompanying noxious odor.

While the present invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

What is claimed is:

1. A method for deodorizing an odoriferous aqueous system comprising adding to said aqueous system an amount sufficient to deodorize said aqueous system of an organic halogen donor.

2. The method of claim 1, wherein said organic halogen donor is selected from the group consisting of halogenated succinimides, halogenated hydantoins, halogenated isothiazolines and mixtures thereof.

3. The method of claim 2, wherein said halogenated succinimide is selected from the group consisting of N-chlorosuccinimide, N-bromosuccinimide and mixtures thereof.

4. The method of claim 2, wherein said halogenated hydantoin is selected from the groups consisting of 1-bromo-3-chloro-5,5-dimethylhydantion, 1,3-dichloro-5,5-dimethylhydration, 1,3-dibromo-5,5-dimethylhydantion and mixtures thereof.

5. The method of claim 2, wherein said halogenated isothiazoline is selected from the group consisting of 5-chloro-2-methyl-4-isothiazolin-3-one, 5-bromo-2-methyl-4-isothiazolin-3one and mixtures thereof.

6. The method of claim 1, wherein said organic halogen donor is added to said aqueous system in an amount of from about 1 to about 1,000 parts per million.

7. The method of claim 1, wherein said organic halogen donor is added to said aqueous system in an amount of from about 1 to about 500 parts per million.

8. A method of deodorizing the odoriferous atmosphere of an aqueous system comprising spraying into said atmosphere an aqueous solution of an organic halogen donor.

9. The method of claim 8, wherein said organic halogen donor is selected from the group consisting of halogenated succinimides, halogenated hydantoins, halogenated isothiazolines and mixtures thereof.

10. The method of claim 9, wherein said halogenated succinimide is selected from the group consisting of N-chlorosuccinimide, N-bromosuccinimide and mixtures thereof.

11. The method of claim 9, wherein said halogenated hydantoin is selected from the groups consisting of 1-bromo-3-chloro-5,5-dimethylhydantion, 1,3-dichloro-5,5-dimethylhydantion, 1,3-dibromo-5,5-dimethylhydantion and mixtures thereof.

12. The method of claim 9, wherein said halogenated isothiazoline is selected from the group consisting of 5-chloro-2-methyl-4-isothiazolin-3-one, 5-bromo-2-methyl-4-isothiazolin-3-one and mixtures thereof.

13. A method of deodorizing an aqueous solution comprising adding to said aqueous solution an organic halogen donor in an amount sufficient to deodorize said aqueous solution.

14. The method of claim 13, wherein said organic halogen donor is selected from the group consisting of halogenated succinimides, halogenated hydantoins, halogenated isothiazolines and mixtures thereof.

15. The method of claim 14, wherein said halogenated succinimide is selected from the group consisting of N-chlorosuccinimide, N-bromosuccinimide and mixtures thereof.

16. The method of claim 14, wherein said halogenated hydantoin is selected from the group consisting of 1-bromo-3-chloro-5,5-dimethylhydantion, 1,3-dichloro-5,5-dimethylhydantion, 1,3-dibromo-5,5-dimethylhydantion and mixtures thereof.

17. The method of claim 14, wherein said halogenated isothiazoline is selected from the group consisting of 5-chloro-2-methyl-4-isothiazolin-3-one, 5-bromo-2-methyl-4-isothiazolin-3-one and mixtures thereof.

18. The method of claim 13, wherein said organic halogen donor is added to said aqueous solution in an amount of from about 1 to about 1,000 parts per million.

19. The method of claim 13, wherein said organic halogen donor is added to said aqueous solution in an amount of from about 1 to about 500 parts per million.
